(19) United States
(12) Patent Application Publication
(10) Pub. No.: US 2012/0240085 A1
(43) Pub. Date: Sep. 20, 2012

(54) ELECTRONIC BOOK READER

(75) Inventors: Wong Hoo Sim, Singapore (SG); Seh Eing Lim, Singapore (SG); Kin Fui Chong, Singapore (SG); Willie Png, Singapore (SG)

(73) Assignee: CREATIVE TECHNOLOGY LTD, Singapre (SG)

(21) Appl. No.: 13/513,182

(22) PCT Filed: Nov. 15, 2010
(86) PCT No.: PCT/SG2010/000432

§ 371 Date: May 31, 2012

(30) Foreign Application Priority Data
Dec. 1, 2009 (SG) 200907968-2

(51) Int. Cl. G06F 3/14

(52) U.S. Cl. 715/864

(57) ABSTRACT

An electronic book reader, the electronic book reader comprising: a reading interface for accessing an electronic book; a display for displaying the electronic book; a network interface for forming a communication connection between the electronic book reader and a device through a server, the server being connected to data storage comprising data of one or more user accounts associated with the electronic book; and a communication interface for facilitating exchange of multimedia messages between the electronic book reader and the device across the communication connection, wherein the communication connection being formed upon activation of the communication interface and upon both the electronic book and the device being logged in to the server via one of the one or more user accounts associated with the electronic book.

### FIELD OF INVENTION

The present invention relates to an electronic book reader.

### BACKGROUND

Compared to mobile phones, netbooks, tablet personal computers, laptop computers, and the like, current electronic book (‘ebook’ for short) readers intended mainly for ebook reading appear lacklustre in terms of the number of features available.

Conventionally, electronic book readers are designed to be simple to bring down the manufacturing cost. An example of a simple electronic book reader is one having a display for displaying ebooks, data storage for storing ebooks, a basic reading interface for retrieving the stored ebooks in the data storage for displaying on the display, and a connector, typically a Universal Serial Bus (USB) connector, for connecting the ebook to an external device for downloading ebooks into the data storage of the electronic book reader from the external device. Better models incorporate wired/wireless internet connection features mainly to allow one to purchase and download ebooks on the go.

As the cost of powerful and power efficient hardware components have decreased, and software development have become easier due to the wide availability of tools and resources, some being free of charge, electronic book readers are in need of a revamp to provide better user experience.

It is appreciated that while some mobile phones, electronic notebooks, tablet personal computers, laptop computers, and the like could also provide ebook reading type features, the user experience provided by such devices for ebook reading are usually not satisfactory. For instance, the display may be too large or too small, the ebook reading orientation of the device may be awkward, the loading time may be long, and the controls to access ebooks and the internet for ebook related purposes may be non-existent or lacking intuitiveness and user friendliness.

A need therefore exists to provide an electronic book reader that addresses at least one of the above-mentioned needs and problems.

### SUMMARY

In accordance with one aspect of the present invention, there is provided an electronic book reader, the electronic book reader comprising: a reading interface for accessing an electronic book; a display for displaying the electronic book; a network interface for forming a communication connection between the electronic book reader and a device through a server, the server being connected to data storage comprising data of one or more user accounts associated with the electronic book; and a communication interface for facilitating exchange of multimedia messages between the electronic book reader and the device across the communication connection, wherein the communication connection being formed upon activation of the communication interface and upon both the electronic book and the device being logged in to the server via one of the one or more user accounts associated with the electronic book.

The communication interface may be capable of establishing a one-to-one communication session between the electronic book reader and the device wherein all multimedia messages exchanged between the electronic book reader and the device are accessible only to the electronic book reader and the device.

The communication interface may be capable of establishing a one-to-many communication session between the electronic book reader and more than one of said device, wherein all multimedia messages exchanged between the electronic book reader and the more than one of said device are accessible to all devices, including the electronic book reader.

The electronic book reader may comprise a selection interface for associating a user account with an electronic book.

The communication interface may comprise a listing identifying the one or more user accounts associated with the electronic book, the listing being displayed on the display together with the electronic book.

The listing may contain only entries associated with the one or more user accounts associated with the electronic book.

The communication interface may comprise a window for displaying a still image representative of a user or a real-time image capture of the user.

The electronic book reader may comprise an accelerometer for detecting orientation of the electronic book reader, wherein in a portrait orientation, a window displayed in the electronic book reader is sized according to the portrait orientation, wherein in a landscape orientation, the window is sized according to the landscape orientation.

A word or phrase in the electronic book may be hyperlinked to one or more windows related to the subject matter of the word or phrase when the word or phrase is highlighted by a user.

The electronic book reader may further comprise an annotation interface for annotating words or phrases in an electronic book by attaching one or more hyperlinks to the words or phrases.

The communication interface may be a program run on the server.

The communication interface may comprise a filter program for filtering devices forming communication connection with the electronic book reader.

### BRIEF DESCRIPTION OF THE DRAWINGS

Embodiments of the invention will be better understood and readily apparent to one of ordinary skill in the art from the following written description, by way of example only and in conjunction with the drawings, in which:

FIG. 1 illustrates a device of an example embodiment of the present invention in portrait orientation.

FIG. 2 illustrates a device of an example embodiment of the present invention in landscape orientation.

FIG. 3 illustrates a communication interface of an example embodiment of the present invention in portrait orientation.

FIG. 4 illustrates the communication interface in FIG. 3 in landscape orientation.

FIG. 5 illustrates windows providing services in an example embodiment of the present invention.

FIG. 6 illustrates windows providing services in an example embodiment of the present invention.

### DETAILED DESCRIPTION

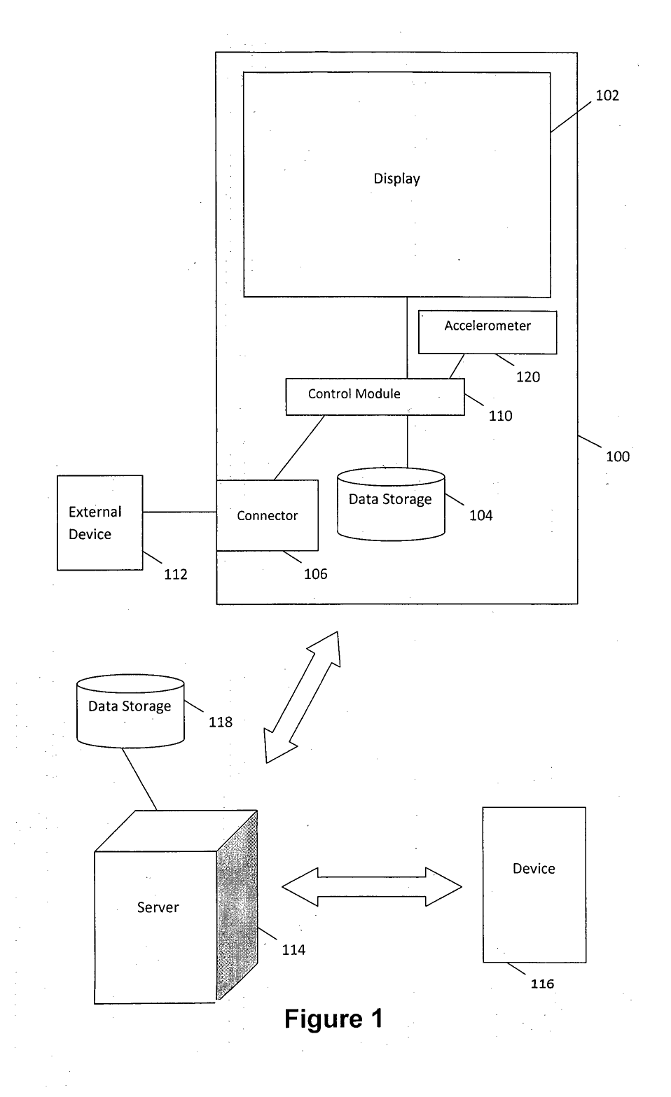

FIG. 1 shows an electronic book reader 100 of an example embodiment of the present invention. The electronic book reader 100 has a display 102 for displaying electronic books (also known as ebooks), a first data storage 104 for storing electronic books and other data related and usable by the electronic book reader 100, a connector 106 for connecting the electronic book to an external device 112 for downloading data, including electronic book files, into the first data storage 104 of the electronic book reader 100 from the external device 112, and a control module 110 for executing software carrying out the operations of the electronic book reader 100. The connector 106 may operate based on technologies such as Universal Serial Bus (USB), Fireware, and the like.

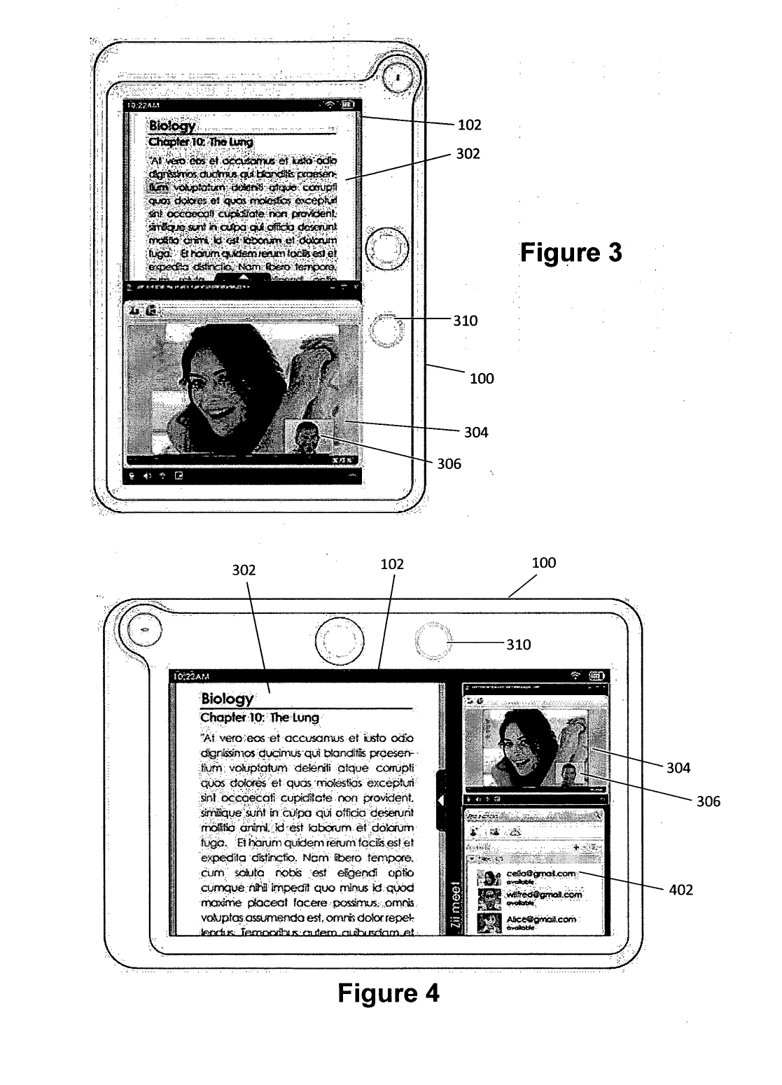

The operations of the electronic book reader 100 include accessing an electronic book via a reading interface (302 in FIGS. 3 and 4), displaying the electronic book, forming a communication connection between the electronic book reader 100 and a remote device 116 through a server 114, and facilitating exchange of multimedia messages between the electronic book reader 100 and the remote device 116 through the server 114. The server 114 is connected to a second data storage 118 containing data of one or more user accounts associated with the electronic book. The communication connection is formed upon activation of the communication interface and upon both the electronic book reader 100 and the remote device 116 being logged in to the server 114 via one of the one or more user accounts associated with the electronic book.

The operations of the electronic book reader 100 may further include associating a user account with an electronic book and generating a listing (e.g. the listing residing in the text messaging interface 402 in FIG. 4) identifying the one or more user accounts associated with the electronic book. The listing may be displayed on the display 102 together with the electronic book. The listing may contain only the one or more user accounts that assist devices to log in to the server 114 and which are associated with the electronic book. Moreover, the operations may include displaying a still image representative of a user of one of the one or more user accounts or a real-time image capture of the user. The operations may also include detecting orientation (portrait or landscape) of the electronic book reader 100 via an accelerometer 120 connected to the control module 110 and carrying out actions based on the detected orientation.

In the example embodiment, the data of the one or more user accounts associated with the electronic book that are stored in the second data storage 118 are structured in a manner such that they are conceptually in table form. Each table is representative of a particular electronic book, and each table consists of unique identifiers, which are each linked to a user account. Examples of a unique identifier could be the username of the user account, or it could be a unique string of data randomly assigned by the server 114.

A user account is created when a user registers to the services provided by the server 114 through a web portal hosted by the server 114. User registration is performed in a manner known to a person skill in the art. Users may be, for instance, required to provide a username and a password at the point of registration.

In the example embodiment, users can log in to the server 114 via the web portal hosted by the server 114 from their remote device 116 to associate their registered user account with a particular electronic book. It is appreciated that server logging in procedures are known to a person skilled in the relevant art. When the association is made, the unique identifier linked with a user account would be recorded as an entry in the table associated with the particular electronic book.

Examples of the external device 112 and the remote device 116 are mobile phones, electronic notebooks, tablet personal computers, laptop computers, desktop computers, and the like. Examples of the first data storage 104 and the second data storage 118 are flash memory, hard disk drives, and the like.

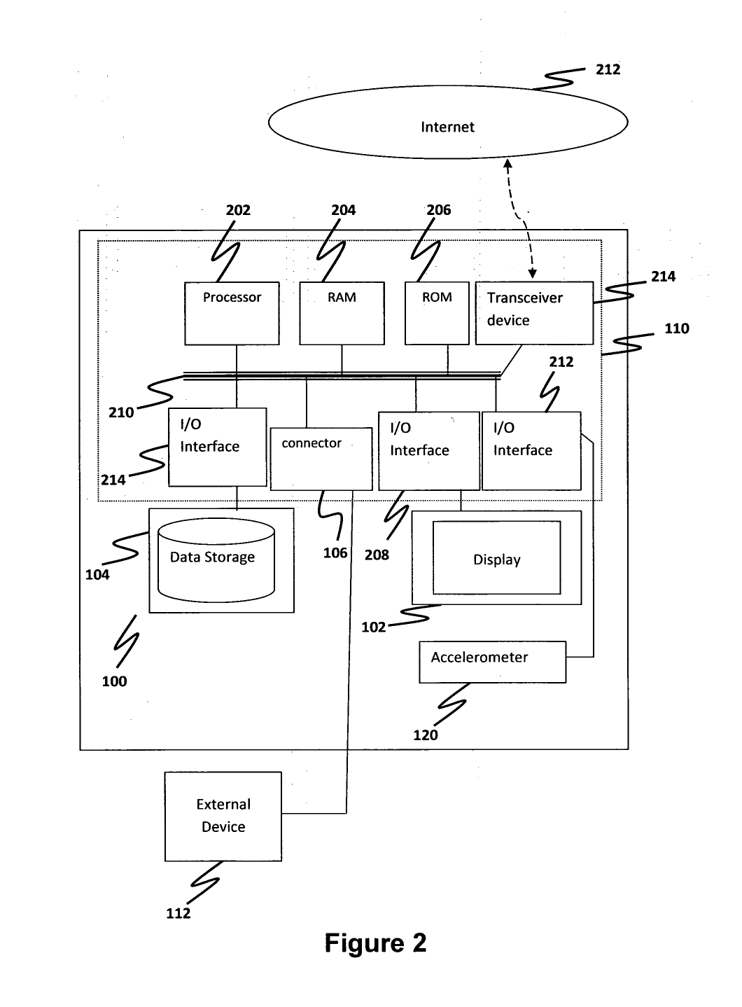

With reference to FIG. 2, the control module 110 described in FIG. 1 includes a processor 202, a Random Access Memory (RAM) 204 and a Read Only Memory (ROM) 206. The control module 110 also includes a number of Input/Output (I/O) interfaces, for example, I/O interface 208 to the display 102, I/O interface 212 to the accelerometer 120, I/O interface 214 to the data storage 104 and the connector 106, which is another I/O interface, to the external device 112. The aforementioned components of the control module 110 typically communicate via an interconnected bus 210 and in a manner known to the person skilled in the relevant art.

The control module 110 is connected to the Internet 212 or other computer network systems such as a wired/wireless Local Area Network (LAN) or Wide Area Network (WAN) via a suitable transceiver device 214 (i.e. a network interface). The transceiver device 214 enables the electronic book reader 100 to connect to the server 114 by way of logging in with a user account. The server 114 is a third party computer system connected to the Internet 212. Through the server 114, the control module 110 can establish a communication connection via the internet with the remote device 116, which is also connected to the server 114 by way of logging in with a user account. In the example embodiment, the transceiver device 214 is built in the control module 110. It is appreciated that in other example embodiments, the transceiver device 214 may be a separate unit connected to the control module 110. The transceiver device 214 may comprise one or more separate transceiver interfaces supporting wired and/or wireless connection to the Internet 212. For instance, for wireless connection, the transceiver device 214 may be a WiFi transceiver, Bluetooth module for Bluetooth communication, Mobile telecommunication transceiver suitable for Global System for Mobile Communication (GSM), 3G, 3.5G, 4G telecommunication systems, and the like. For wired connection, the transceiver device 214 may be for instance an Ethernet modem.

The operations of the control module 110 are carried out by one or more software applications. The software applications may include applications for instant messaging, audio/video playback, video conferencing tools, internet accessibility, operating an operating system (OS) (such as Android OS, Windows™ Mobile, Symbian OS, Web OS, Palm OS, and the like), network security, file accessibility, database management etc.

FIG. 3 illustrates a communication interface of the electronic book reader 100 on the display 102 in portrait orientation. There are two windows in the display 102. One of the windows is the reading interface 302 for accessing an electronic book and it enables users to read the electronic book on the display 102. The other window is part of the communication interface, which is a video conferencing interface 304 for communicating with a remotely located user who has logged in to the server 114 through a user account that is associated with the electronic book. The video conferencing interface 304 could be configured to display a still image representative of the remotely located user or it could display a real-time image capture of the remotely located user. In the main window display of the video conferencing interface 304, there could be a smaller window display 306 (i.e. a picture-in-picture interface) displaying a still image representative or a real-time image capture of a current user of the electronic book reader 100. A camera 310 connected to the control module 110 may be mounted to the electronic book reader 100 to capture the real-time images of the current user of the electronic book reader 100 for displaying on the smaller window display 306.

FIG. 4 illustrates the same communication interface of the electronic book reader 100 on the display 102 in landscape orientation. There are three windows in the display 102. One of the windows is the reading interface 302, a second window is the video conferencing interface 304 and a third window, which is also part of the communication interface, is a text messaging interface 402. The text messaging interface 402 displays a listing of remotely located users whose user accounts are associated with the electronic book.

It is appreciated that there could be configurations available in the communication interface allowing users to filter users shown in the listing to establish communication with. This can be done via a filter program incorporated in the communication interface. For instance, the communication interface may be configured to facilitate establishing of one-to-one communication sessions between a user of the electronic book reader 100 and a second user who had remotely logged in to the server 114 with a user account associated with the electronic book using a second device. All users other than the second user who had remotely logged in to the server 114 are filtered out, i.e. all the devices of these users are filtered out from forming a communication connection with the electronic book reader 100 by the filter program. The communication interface is capable of establishing communication connection between the electronic book reader 100 and the second device. During such one-to-one communication sessions, all multimedia messages (i.e. data files, video/audio streaming, and text messages) exchanged are accessible (i.e. capable of being received and displayed at the respective device) only to the electronic book reader 100 and the device of the second user. Privacy for the two parties in a one-to-one communication session thus ensured.

The communication interface may also be configured to facilitate establishing of one-to-many communication sessions between a user of the electronic book reader 100 and one or more selected users who had remotely logged in to the server 114 with user accounts associated with the electronic book using separate devices. All unselected users who have remotely logged in to the server 114 are filtered out, i.e. all the devices of these users are filtered out from forming a communication connection with the electronic book reader 100 by the filter program. In this case, the communication interface is capable of establishing communication connection between the electronic book reader 100 and the separate devices. During the one-to-many communication sessions, all multimedia messages (i.e. data files, video/audio streaming, and text messages) exchanged between the electronic book reader 100 and the separate devices are accessible (i.e. capable of being received and displayed at the respective device) to all devices, including the electronic book reader 100.

It is appreciated that one or more one-to-one communication sessions may be running concurrently with one or more one-to-many communication sessions. That is, for instance, in one session, a user could be communicating with many parties where everyone can receive and read multimedia messages sent between all parties and in another concurrently running session, the user could be communicating with one party and only both the user and that party can receive and read multimedia messages sent between both of them.

The advantage of having one or more one-to-one communication sessions running concurrently with one or more one-to-many communication sessions is illustrated as follows.

For example, there is a classroom with a teacher using the electronic book reader 100. Each of the students in the classroom is also using a device similar to the electronic book reader 100 or they could be using other electronic book reading devices with internet connection capabilities. Importantly, for this example, each of the devices in use is preinstalled with the software of the communication interface. The teacher and all the students all have individual user accounts registered with the server 114. They need to log in to the server 114 through their user accounts using the software of the communication interface to make use of the functions of the communication interface.

The teacher has prepared an electronic book file which has been pre-annotated and distributed to all the students and all the students can view the electronic book on their devices. Distribution of the electronic book file can be made electronically through the server 114 via a suitable server program since the devices of the teacher and the student are logged in to the server 114. Alternatively, the electronic book file can be distributed via wireless technologies such wireless LAN, Bluetooth, GSM/3G technologies, wired Ethernet connection, and the like.

During the class, upon opening the electronic book using the communication interface, the teacher and students establish a one-to-many communication session where the teacher and all the students can communicate with one another in a “broadcast” manner, where every message would be received by everyone. Using the filter program, the teacher could make settings such that only him or her and the students logging in with their user accounts are entered in the one-to-many communication session. Other parties who have logged in with other user accounts associated with the electronic book would be filtered out of the one-to-many communication session. It is appreciated that the settings of the filter program could be set prior to the teacher and students opening the electronic book. For shy students, they may initiate a one-to-one communication session with the teacher, which is running concurrently with the one-to-many communication session. In this manner, advantageously, shy students can communicate with the teacher without scrutiny from the other students, which may occur if they are communicating in the one-to-many communication session.

It is appreciated that in other example embodiments, the communication interface could be a server program ran on the server 114. The server program could be activated from a web portal hosted by the server 114. In this case, there is no need to preinstall the software of the communication interface on all the devices establishing a communication connection via the communication interface.

When the electronic book reader 100 is changed from portrait orientation (illustrated by FIG. 3) to landscape orientation (illustrated by FIG. 4) or vice versa, the accelerometer 120 of the electronic book reader 100 detects the change in orientation and would feedback data to the control module 110 to cause the communication interface to size the windows shown in the display 102 according to how it is illustrated in FIGS. 3 and 4. In this manner, the electronic book reader 100 would be optimised for electronic book reading during portrait and landscape orientations.

It is appreciated that the electronic book reader 100 could further include a selection interface for users to associate a user account with an electronic book. This selection interface could be a panel, which can be called out via the communication interface, and the panel may list options for users to associate their user accounts with the electronic book.

One problem with conventional electronic book readers and electronic book reader type devices such as some mobile phones, netbooks, tablet personal computers, laptop computers, and the like is the lack of interconnectivity and features for interaction between authors and readers of electronic books and interaction between readers of electronic books. By providing the hardware and software setup according to the electronic book reader 100 as described with reference to FIGS. 1 to 4, the problem can be solved. For instance, authors of an electronic book and other readers of the electronic book can be linked up via the communication interface comprising the video conferencing 304 and the text messaging interface 402.

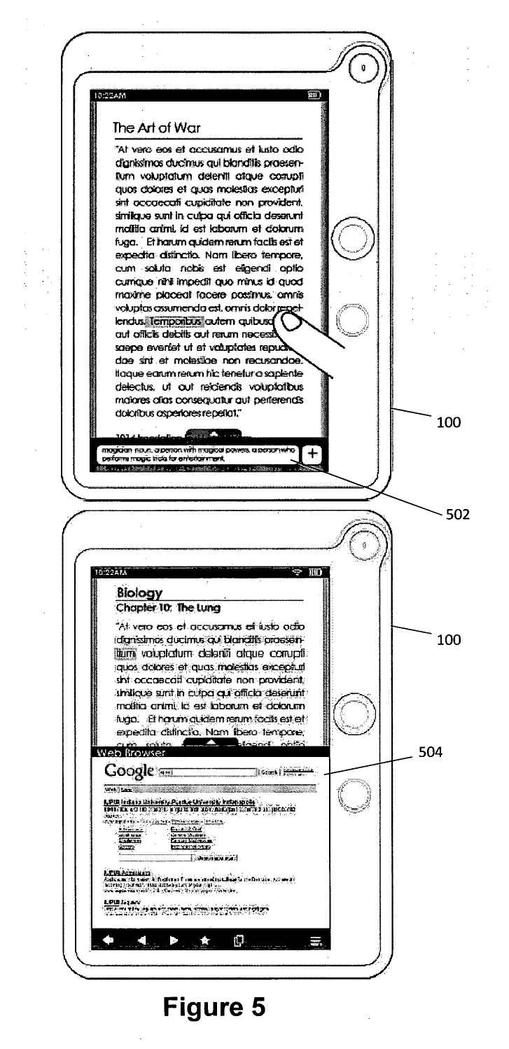

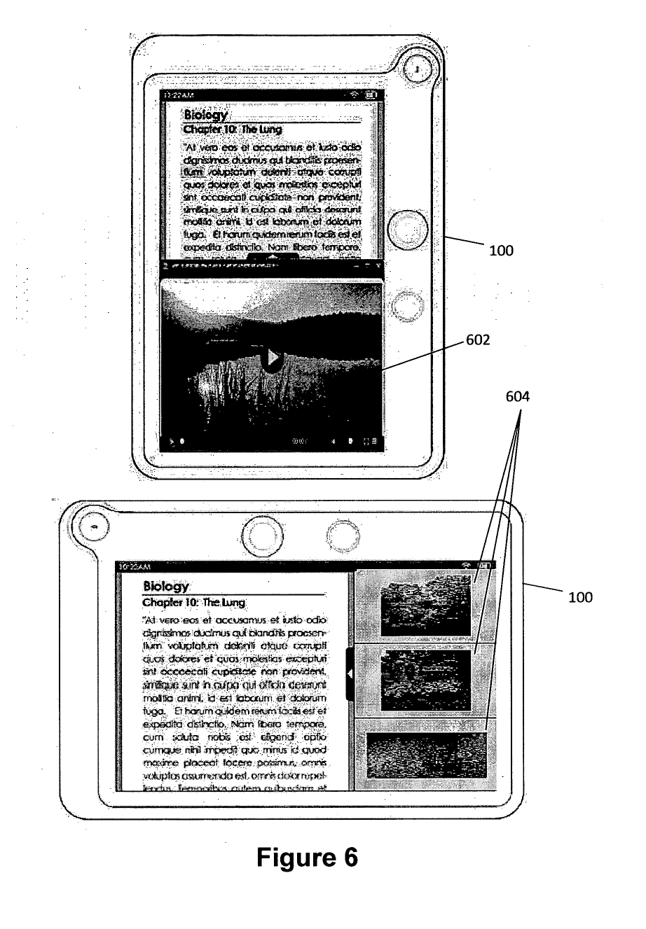

FIGS. 5 and 6 show various views of the electronic book reader 100 described above with reference to FIGS. 1 to 4. The reading interface 302 of the electronic book reader 100 may be configured to display a listing (not shown in FIGS. 5 and 6) containing one or more hyperlinks to one or more windows 502, 504, 602 and 604 upon a user highlighting the words or phrases in an electronic book displayed on the display 102. That is, the words or phrases are hyperlinked to the windows when they are highlighted. These words could be pre-annotated with hyperlinks before distribution for reading like in the case of the classroom example discussed previously. The windows may be web pages or multimedia content providing various services related to the subject matter of the words or phrases. Examples of some services are dictionary providing meaning of the words or phrases i.e. window 502, search engine web page providing hits related to the words or phrases i.e. window 504, web pages providing goods and services related to the words or phrases, video/audio clips relating to the subject matter of the words or phrases i.e. the video clip window 602, pictures relating to the subject matter of the words or phrases i.e. windows 604, web pages providing information on the subject matter of the words or phrases (e.g. encyclopedia websites), other electronic books or software related to the subject matter of the words or phrases etc. The listing may be displayed as a menu containing all the hyperlinks to the respective windows that are related to the highlighted words or phrases. If there is only one hyperlink for the highlighted word or phrase, the window in which the hyperlink is linked to would be displayed in place of the listing. Highlighting of words or phrases can be made by way of, for instance, simply selecting the words or phrases, selecting and dragging from the starting character of the word or phrase to the last character of the word or phrase, circling the word or phrase, and the like. It is appreciated that if the display 102 is touch technology enabled, selection can be made by contacting the display surface with a user's finger or a stylus. If there is a computer mouse-like feature, selection can be made by moving a computer mouse-like device to control movement of a selector in the display 102 and clicking a button on the computer mouse-like device when the selector is at a desire position of the display 102.

It is appreciated that the electronic book reader 100 could further include an annotation interface for users to annotate words and/or phrases in an electronic book by attaching to the words and/or phrase one or more hyperlinks linked to related web pages, video/audio clips, electronic book(s), software etc.

Many modifications and other embodiments can be made to the electronic book reader and the methodologies herein described by those skilled in the art having the understanding of the above described disclosure together with the drawings. Therefore, it is to be understood that the electronic book reader and its utility is not to be limited to the above description contained herein only, and that possible modifications are to be included in the claims of the disclosure.

1. An electronic book reader, the electronic book reader comprising:
a reading interface for accessing an electronic book;
a display for displaying the electronic book;
a network interface for forming a communication connection between the electronic book reader and a device through a server, the server being connected to data storage comprising data of one or more user accounts associated with the electronic book; and
a communication interface for facilitating exchange of multimedia messages between the electronic book reader and the device across the communication connection,
wherein the communication connection being formed upon activation of the communication interface and upon both the electronic book and the device being logged in to the server via one of the one or more user accounts associated with the electronic book.

2. The electronic book reader as claimed in claim 1, the communication interface being capable of establishing a one-to-one communication session between the electronic book reader and the device wherein all multimedia messages exchanged between the electronic book reader and the device are accessible only to the electronic book reader and the device.

3. The electronic book reader as claimed in claim 1, the communication interface being capable of establishing a one-to-many communication session between the electronic book reader and more than one of said device, wherein all multimedia messages exchanged between the electronic book reader and the more than one of said device are accessible to all devices, including the electronic book reader.

4. The electronic book reader as claimed in claim 1, the electronic book reader comprising:
a selection interface for associating a user account with an electronic book.

5. The electronic book reader as claimed in claim 1, the communication interface comprising a listing identifying the one or more user accounts associated with the electronic book, the listing being displayed on the display together with the electronic book.

6. The electronic book reader as claimed in claim 5, the listing contains only entries associated with the one or more user accounts associated with the electronic book.

7. The electronic book reader as claimed in claim 1, the communication interface comprising a window for displaying a still image representative of a user or a real-time image capture of the user.

8. The electronic book reader as claimed in claim 1, the electronic book reader comprising:
an accelerometer for detecting orientation of the electronic book reader,
wherein in a portrait orientation, a window displayed in the electronic book reader is sized according to the portrait orientation,
wherein in a landscape orientation, the window is sized according to the landscape orientation.

9. The electronic book reader as claimed in claim 1, wherein a word or phrase in the electronic book is hyperlinked to one or more windows related to the subject matter of the word or phrase when the word or phrase is highlighted by a user.

10. The electronic book reader as claimed in claim 1, the electronic book reader further comprising:
an annotation interface for annotating words or phrases in an electronic book by attaching one or more hyperlinks to the words or phrases.

11. The electronic book reader as claimed in claim 1, wherein the communication interface is a program run on the server.

12. The electronic book reader as claimed in claim 1, wherein the communication interface comprising a filter program for filtering devices forming communication connection with the electronic book reader.
